(19) United States
(12) Patent Application Publication
(10) Pub. No.: US 2026/0063135 A1
(43) Pub. Date: Mar. 5, 2026

(54) PUMPING RING FOR ROTARY SHAFT EQUIPMENT SEALS

(71) Applicant: John Crane Inc., Morton Grove, IL (US)

(72) Inventors: Arnaldo Lopez, Pearland, TX (US); Rafael Victor Pires Costa, Reading (GB); Tebogo Kwena Junior Moloto, Reading (GB); Mica Jenn Ramos Gapasin, Edmonton, Alberta (CA); Nikita Gupta, Maidenhead (GB); Laura Brito Uriostegui, Chicago, IL (US)

(21) Appl. No.: 19/285,308

(22) Filed: Jul. 30, 2025

Related U.S. Application Data
(60) Provisional application No. 63/677,902, filed on Jul. 31, 2024.

(51) Int. Cl. F04D 29/12; F04D 29/58; F16J 15/34

(52) U.S. Cl. CPC F04D 29/126; F04D 29/586; F16J 15/34

(57) ABSTRACT

A mechanical seal assembly configured to be coupled to a rotating shaft of a machine, includes: rotating and stationary rings configured so that rotating ring rotates with the shaft and relative to the stationary ring; and a rotating ring drive ring that includes features formed at least on an outer surface thereof, the rotating drive ring configured to hold the rotating ring in a fixed relationship relative the rotating shaft. The features can increase the flow rate of cooling fluid near the seal when in operation.

### CROSS REFERENCE TO RELATED APPLICATIONS

This application claims the benefit of an earlier filing date from U.S. Provisional Application Ser. No. 63/677,902 filed Jul. 31, 2024, the entire disclosure of which is incorporated herein by reference.

### TECHNICAL FIELD

This invention relates to rotary shaft equipment having mechanical seal assemblies providing a seal between a stationary housing and rotatable shaft of the rotary shaft equipment.-More particularly, it relates to such rotary shaft equipment that provide a pumping ring to interact with a seal flush liquid used to cool a mechanical seal assembly.

### BACKGROUND

Mechanical seals are used to provide a seal between a rotating shaft and a stationary housing of a pump, compressor, turbine, or other rotating machine. End face mechanical seals generally include a primary seal interface comprising two relatively rotatable seal faces. Frictional wear between the seal faces can cause a gap to form therebetween, leading to excessive leakage. Accordingly, some end face seals require regular adjustment in order to maintain the appropriate or axial position of an axially shiftable seal member (also known as “seal height”) in order to account for such wear.

Various biasing mechanisms have been contemplated to provide a closing force to automatically accommodate wear. Such biasing mechanism have included single and multiple coil springs, and metal bellows.

Pusher seal assemblies comprise a dynamic secondary seal (such as an o-ring) to provide a seal between the shaft and the seal members themselves. The dynamic secondary seal of pusher seals is generally configured to move axially with the axially shiftable seal member. This axial movement relative to the shaft can cause fretting or shredding of the secondary seal due to friction.

Non-pusher seals generally feature a secondary shaft seal that is not intended to move axially relative to the shaft or an elastomeric bellows.

Regardless of the type of seal, the seal will often be provided a flush liquid to lubricate and cool the seal faces. The flush liquid can be taken from outlet of the rotary machine (e.g., pump) and provided back into the seal chamber at a pressure that causes it to be directed back into the chamber of the seal.

### SUMMARY

Embodiments of the present disclosure meet may result in increased circulation of the flush fluid that would enable to increase cooling between the flush liquid and the mechanical seal to increase cooling of the seal.

According to embodiments, a pumping ring is disclosed. The pumping ring can include complex features and may be formed, for example, by additive manufacturing. Examples of such features more fully described below include Sine Wave, Core Flow and Impeller features formed on the outer surface of the pumping ring. The pumping ring can be a separate ring From the retainer that holds the rotating ring.

Alternatively, the ring can be a drive ring with the features provided on thereon

Also disclosed is volute that can be disposed within the gland (or other) plate that will surround the pumping/drive ring and can further improve cooling. Alternatively, the volute can be disposed within an adequately cut groove in the seal chamber of the pump. The volute can be used on its own or in combination with any pumping/drive ring disclosed herein.

In one embodiment, a pump system is disclosed. The system includes a pump having a housing and a pump outlet and that is driven by a rotating shaft and a mechanical seal assembly coupled to and surrounding the rotating shaft that seals a fluid in a chamber of the pump so that liquid in the chamber exits the pump via the pump outlet. The mechanical seal assembly is disposed in the housing and includes: rotating and stationary rings configured so that rotating ring rotates with the shaft and relative to the stationary ring; and a rotating ring drive ring that includes features formed at least on an outer surface thereof, the rotating drive ring configured to hold the rotating ring in a fixed relationship relative to the rotating shaft.

In another embodiment, a mechanical seal assembly configured to be coupled to a rotating shaft of a machine is disclosed. The seal assembly can include: rotating and stationary rings configured so that rotating ring rotates with the shaft and relative to the stationary ring; and a rotating ring drive ring that includes features formed at least on an outer surface thereof, the rotating drive ring configured to hold the rotating ring in a fixed relationship relative to the rotating shaft.

In addition to or in combination with any of the above embodiments the features can be wave-like regions.

In addition to or in combination with any of the above embodiments, adjacent features are separated by a trough.

In addition to or in combination with any of the above embodiments, the wave-like regions extend from an outer diameter of the rotating ring drive ring to the trough.

In addition to or in combination with any of the above embodiments, the wave-like regions can define a sinusoidal or oscillating pattern.

Alternatively, the features can be impeller features or blade like features. The features are at a front of the rotating ring drive ring and can extend radially inward from an outer diameter of the rotating ring drive ring. In one embodiment, the features extend to a radial inner wall formed in the front of the rotating ring drive.

Alternatively, the features can be channel features. The features can be formed such they fluidly connect an outer diameter of the rotating ring drive ring to a front of the rotating ring drive ring. The features include a hole in the outer diameter and a hole in the front of the rotating ring drive ring and fluidly connect hole in the outer diameter and the hole in the front of the rotating ring drive ring.

In the pump embodiments, the pump can include: a gland plate coupled to the housing such that it defines a cooling chamber between the housing and the rotating and stationary rings, the gland plate including a flush inlet that is in fluid communication with the chamber. A volute disposed or formed in the gland plate and surround the rotating ring drive ring.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1A is a cross-sectional view showing a rotating machine with a mechanical seal according to one embodiment;

FIG. 1B is a cross-sectional view showing a rotating machine with a mechanical seal according to one embodiment;

FIG. 2 shows a perspective view of a rotating ring drive ring that includes wavy features on the outer diameter;

FIG. 3 shows a perspective view of a rotating ring drive ring that includes an impeller formed thereon;

FIG. 4 shows a perspective view of a rotating ring drive ring that includes cavity (core flow) features formed therein;

FIG. 5A shows a perspective view of a volute that may be used in combination with any rotating ring drive ring disclosed herein and disposed in a gland plate;

FIG. 5B shows the volute of FIG. 5A; and

FIG. 5C shows a plan and cross sectioned view of a flattened version of the volute of FIG. 5B.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Turning now to an overview of technologies that are more specifically relevant to aspects of this disclosure, a new manner of cooling rings or other elements of mechanical seals is provided. The cooling can be provided by providing features at a surface that moves with the a rotating ring in the seal. For example, the features can be on a surface (e.g., outer diameter) of a rotating ring drive ring or on a separately formed pumping ring that surrounds the rotating drive ring. While the rotating ring is shown as a primary ring herein, the teachings could be applied to any rotating ring (e.g., a mating ring). Such features can lead to enhanced fluid movement around 360° of the sealing interface, yielding more efficient heat transfer while minimizing vapor pocket formation.

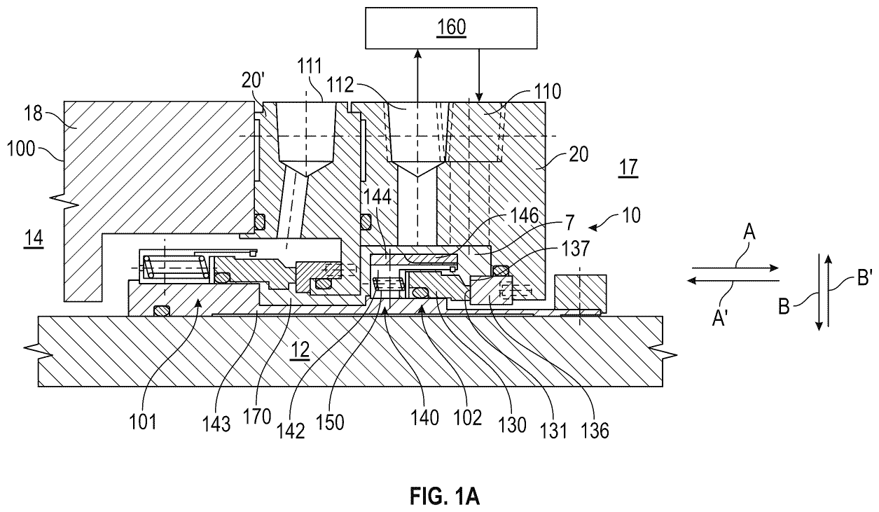

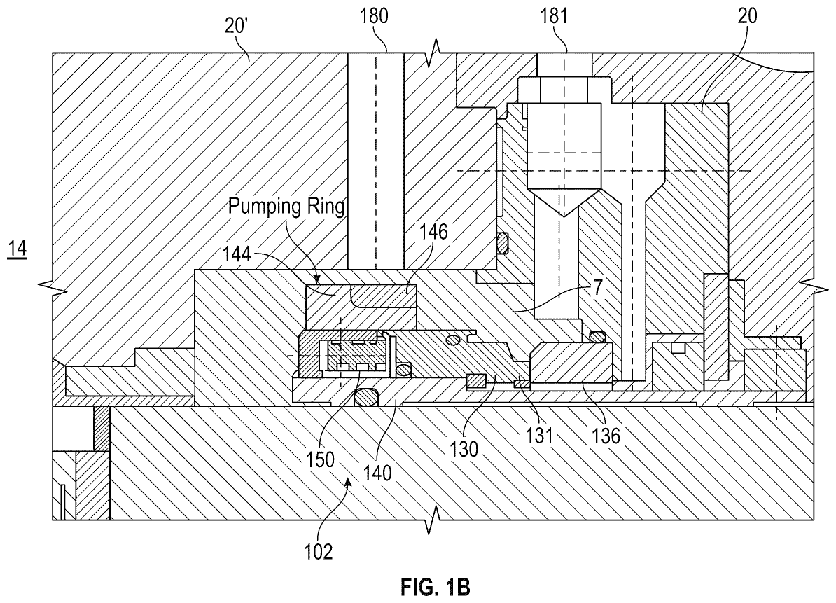

FIG. 1A is a cross-sectional view showing a rotating machine 100 such as a compressor or other pump having mechanical seal assembly 10 that seals a liquid in a chamber 14 of the machine 100. The following discussion will refer to a pump for convenience but that is not meant to limit the teachings to only a pump. FIG. 1 is described in general to both set forth components in embodiments discussed below and to describe the systems to which the embodiments herein may improve. Thus, any element described with relation to FIG. 1 can also form part of any embodiment disclosed herein.

The seal assembly 10 is arranged such that it surrounds the rotating shaft 12 and acts on a liquid (e.g., a hydrocarbon) in the chamber 14 so that it does not escape and possibly enter the atmosphere 17. As shown, the seal assembly 10 includes two seals, a first seal 101 and a second seal 102. The teachings here in can be applied to either or both of the first or second seals 101, 102 as well as the case where only a singular inboard seal is used.

The illustrated assembly 10 is shown according to the so-called API plan 53 where an external reservoir 160 is used to provide pressurized barrier fluid to the illustrated pressurized dual seal (seals 101, 102) configuration. Alternatively, the reservoir could provide un-pressurized barrier fluid to the second seal 102. Such a configuration is commonly referred to as API plan 52.

In either case, the barrier fluid primarily cools the second seal 102 and the liquid in the chamber 14 of the machine 100 may aid in cooling the first seal 101. The teachings herein are applicable to both as well as other plans (e.g., API plan 23 described below).

The seal assembly 10 can be arranged coaxial of the shaft 12 in a bore defined by an annular housing 18 coaxial of shaft 12. Various stationary (or non-rotating) components of seal assembly 10 can be operably coupled to housing 18, or one or more gland plates 20, 20′, which is in turn also operably coupled to housing 18. The seal assembly 10 ensures that the primary path that liquid can exit the chamber 14 is via the pump outlet and so that little to no fluid can exit the chamber 14 via a space between the shaft 12 and the housing 18.

From time to time certain directions will be used herein. An outboard direction is the direction extending in the direction of arrow A and the inboard direction (e.g., towards the chamber 14 described below) is in the opposite direction as indicated by arrow A′. The radially inward direction is in the direction of arrow B which is directed toward a center of the shaft 12 and the radially outward direction is in the opposite direction as indicated by arrow B′. Further, the fluid that has not yet entered the pump (or before it is expelled therefrom) may be referred to as “upstream” of the pump and fluid that has left the pump is “downstream” of the pump 100.

Fluid in chamber 14 is pumped through the machine 100 due to rotation of the shaft 12. In more detail, the shaft 12 will turn elements such as impeller attached thereto and create an operational pressure in the chamber 14.

In the illustrated embodiment of FIG. 1A, the seal assembly 10 (and in particular, seal 102) is in a positive pressure scenario. In such a scenario, barrier fluid is provided into a cooling fluid chamber 7 defined on the outer diameter of the seal 102. As shown the barrier fluid is provided to the cooling fluid chamber 7 from the reservoir 160 via barrier inlet 110 in the gland plate 20. The barrier fluid can then interact with the seals 101, 102, cool the, and then leave via barrier outlet 112. It will be understood that the cooling chamber 7 may include a first seal cooling region 170 proximate the first seal 101 to aid in cooling the first seal 101.

A process fluid inlet 111 can also be provided in the first seal gland plate 20′ to allow for process fluid from the chamber 14 to enter and cool the outer side of the first seal 101.

It has been discovered that at times that cooling of one or both of the seals 101, 102 is less than optimal. This can be due to the fact that the circulation flow rate induced by the pumping rings of the prior art is insufficient. Embodiments herein improve the cooling in the cooling fluid chamber 7 by providing/inducing higher barrier (or other) fluid circulation flow rates by providing improved designs for a pumping ring 144/146 that is part of the seal 102 and in particular, surrounds the rotating ring 130 discussed further below.

In the following discussion an example seal 102 is described. This illustrated seal 102 is an elastomer o-ring seal but it shall be understood that the teachings herein can be applied to any type of rotating seal that includes two rings.

The illustrated seal 102 includes two rings 130, 136 having opposing faces 131, 137 that rotate relative to one another in operation. The rings 130, 136 may be referred to, respectively, as rotating and stationary rings herein. The stationary ring 136 can be fixedly attached to the annular housing 18 or to a gland plate 20 as illustrated. The rotating ring 130 is connected to the shaft 12 by an assembly 140. While the rotating ring 130 shown in FIG. 1A is a so called “primary ring” it shall be understood that the rotating ring could also be a mating ring in the even that the mating is connected to the shaft.

The assembly 140 as illustrated includes a carrier ring 142 and a sleeve member 143 that is fixedly attached to the shaft 12. The carrier ring 142 can be fixedly attached to the sleeve member 143 and can encase some or all of the rotating ring 130.

In general, during operation a liquid film develops between the faces 131, 137 as the faces rotate relative to one another. The rotation is caused by rotation of the shaft 12.

In this example, a first seal biasing mechanism 150 in the carrier ring 142 urges the rings 130, 136 of the seal together. In particular, the first seal biasing mechanism 150 biases the rotating ring 130 towards the stationary ring 136.

The liquid received from flush inlet 110 is generally held at the OD of the seal 102 where the faces 131/137 meet and at the inside of the first seal 101 (e.g., in region 143). Of course, some of the liquid will pass through the seal 102.

The carrier ring 142 is surrounded by a pumping ring 144. Pumping rings are used to circulate process fluid, buffer fluids or barrier fluids as is known in the art. The pumping ring 144 includes pumping elements 146 on an OD thereof. In one embodiment, the pumping ring 144 is a separate element and includes features as described below. In other embodiments, the features can be formed directly on the carrier ring 142.

As noted above, FIG. 1A showed the case where there were two seals are utilized. In an alternative embodiment, only one seal may be used as shown in FIG. 1B. In FIG. 1B, the seal shown is seal 102 for consistency with FIG. 1A. The configuration of FIG. 1b can be referred to as API plan 23. The seal 102 operates as above.

As shown in FIG. 1B, the gland plate 20′ can be provided with a flush outlet 180. This can provide process fluid from region 14 a path out as it cools the outer side of the seal 102. The outlet 180 can be connected to heat exchanger to cool the fluid and then returned to chamber 7 via flush inlet 181. As above, the seal 102 can include a carrier ring 142 surrounded by a pumping ring 144. Pumping rings are used to circulate process fluid, buffer fluids or barrier fluids as is known in the art. The pumping ring 144 includes pumping elements 146 on an OD thereof. In one embodiment, the pumping ring 144 is a separate element and includes features as described below. In other embodiments, the features can be formed directly on the carrier ring 142.

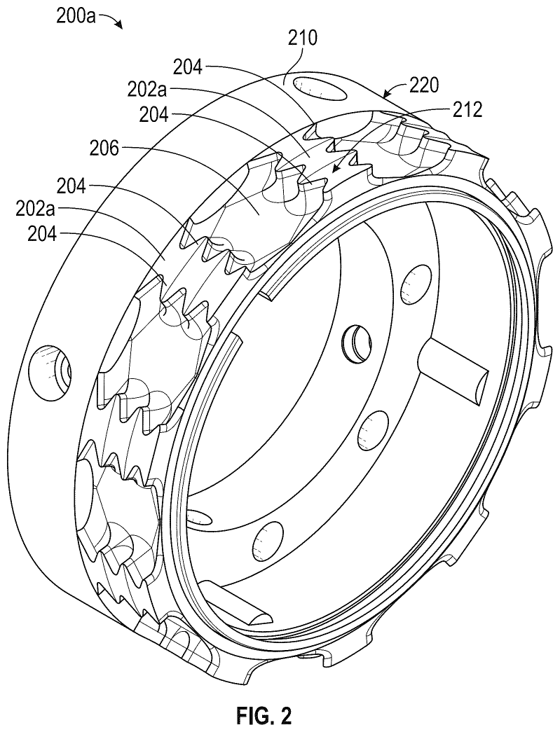

FIG. 2 shows one example of a ring 200a according to one embodiment. The ring 200b can either be a separate ring designed to surround a carrier ring or it can be a carrier ring with features 202 formed thereon. Different rings/features are shown in different embodiments and the features can include the same designation 200, 202 but with a, b, c, etc. added as suffix thereto. Further, features from one embodiment can be combined with features of different embodiments without departing from the teachings herein.

The first example ring 200a includes sine wave features 202a formed on an outer diameter 220 thereof. The ring 200a can be referred to as a sine wave ring herein. As will be understood, the ring 202a will surround the rotating ring 130 (FIG. 1) and any may help cool that ring and the seal in general providing/inducing higher barrier (or other) fluid circulation flow rates.

As shown, the sine wave ring 200a has a smooth region 210 and a feature region 212 that collectively formed on the outer diameter 220 thereof. It shall be understood that the smooth region 210 could be omitted and, thus, the wave features could extend to the rear face of the ring.

The features 202a include a wave-like region 204 that descends radially inward from the outer diameter 220. The wave-like region 204 can have a periodic sine wave shape as shown or any other wave-like shape. The features 202a can include wave-like regions 204 on one side or on both sides as shown in FIG. 2.

A trough 206 is formed between adjacent features 202a on the ring 200a. The combination of the trough 206 and the wave-like regions 204 has been shown through simulation to provide higher pressure to the surrounding sealing (cooling fluid) which results in an increased flow rate of the fluid out of the seal. This improved cooling will lead to better cooling of at least the rotating ring and possibly the entire seal. As with all embodiments herein, the features can be formed in many manners but one example is to form them via additive manufacturing. In such a case, the whole ring 200a (or any other ring disclosed herein) can be additively formed. This can reduce metal removal waste that was present in the prior art. This may also result in part consolidation and reduce required inventory requirements.

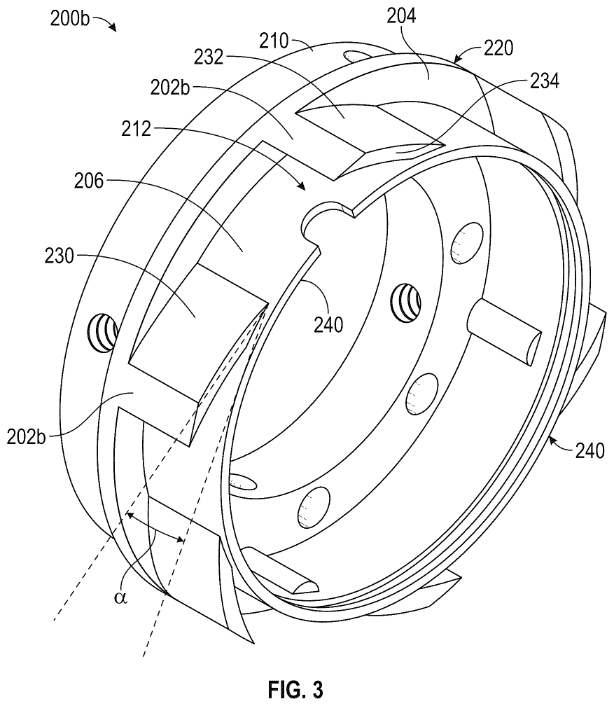

FIG. 3 shows another example of a ring 200b according to one embodiment. The ring 200b can either be a separate ring designed to surround a carrier ring or it can be a carrier ring with features 202b formed thereon.

The second example ring 200b includes impeller features 202b on a front side 240 thereof. The ring 200b can be referred to as an impeller ring herein. As will be understood, the ring 202b will surround the rotating ring 130 (FIGS. 1A, 1B). Ring 200b may also provide higher pressure to the surrounding sealing (cooling fluid) which results in an increased flow rate of the fluid out of the seal. This improved cooling will lead to better cooling of at least the rotating ring and possibly the entire seal.

As shown, the impeller ring 200b has a smooth region 210 and a feature region 212 that collectively form the outer diameter 220 thereof. It shall be understood that the smooth region 210 could be omitted. The impeller features 202b are generally located in the feature region and are in the form of blades that generally extend radially inward at an angle relative to the local radius of the ring 202b.

In more detail, the features 202b include a blade 230 that extends from a location at or near the outer diameter 220 down to a region at or near a bottom of the trough 206 that is formed between the features 202b. That is, while the example blades 230 in FIG. 3 extend between the outer diameter 220 and the trough 206, the blade can be separated from either one or can extend from a location between one of the outer diameter 220 and the trough 206 towards the other the outer diameter 220 and the trough 206.

The blades 230 can extend at a descent angle (α) and have an upper and lower surfaces 232, 234. In more detail, the blade 230 descends radially inward at the descent angle (α) from the outer diameter 220 toward an internal outerwall 240 that defines a bottom of the trough 206. This angle can vary between, for example, 10 and 30 degree with 20 being preferred. The blades 230 can be curved as shown or can have any other bladed, curved or spiral shapes.

As noted, the trough 206 is formed between adjacent features 202b on the ring 200b. The combination of the trough 206 and the blades 230 has been shown through simulation to provide better cooling of the ring 200b than using previous paddle type pumping rings. Similar to the above, this improved cooling will lead to better cooling of at least the rotating ring and possibly the entire seal. As with all embodiments herein, the features 202b can be formed in many manners but one example is to form them via additively manufacturing. In such a case, the whole ring 202b can be additively formed. This can reduce metal removal waste that was present in the prior art. This may also result in part consolidation and reduce required inventory requirements.

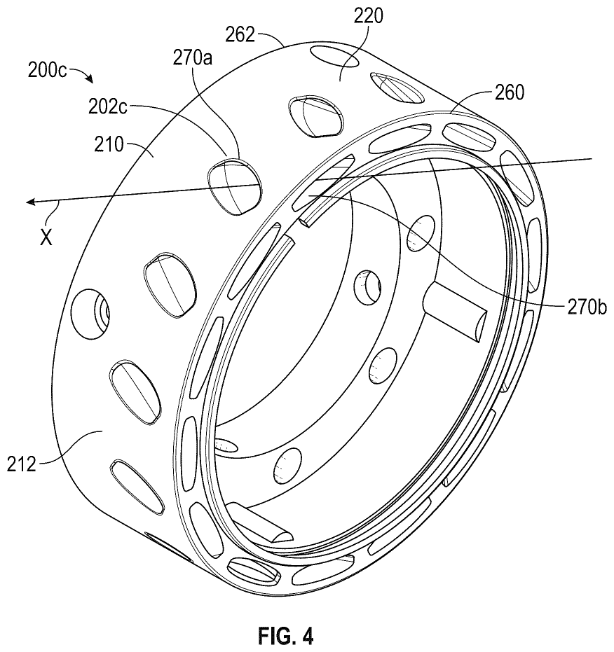

FIG. 4 shows another example of a ring 200c according to one embodiment. The ring 200c can either be a separate ring designed to surround a carrier ring or it can be a carrier ring with features 202c formed thereon.

The third example ring 200c includes core flow features 202 on a front surface 260 thereof. The core flow features can also be called internal cavities or cavity features herein. The ring 200c can be referred to as a core flow ring herein. These features move fluid along a path shown by arrow X in FIG. 4. As will be understood, the ring 202c will surround the rotating ring 130 (FIGS. 1A, 1B). Ring 200c may also provide higher pressure to the surrounding sealing (cooling fluid) which results in an increased flow rate of the fluid out of the seal. This improved cooling will lead to better cooling of at least the rotating ring and possibly the entire seal.

As shown, the core flow ring 200c has a smooth region 210 and a feature region 212 that are collectively formed on the outer diameter 220 thereof. It shall be understood that the smooth region 210 could be omitted. The core flow ring 200c also includes a front surface 260 and a back surface 262.

The core flow ring 200c has core flow features 202c formed therein. The core flow features 202c are generally located in the feature region and are in the form of holes formed such that they provide a fluid flow path between the front surface 260 and the outer diameter 220 and the [symbol] . As the ring 200c rotates counter-clockwise, fluid will pass through the ring 202c in direction X.

In more detail, the features 202c include holes 270a, 270b in the outer diameter 220 and the front face 260. The features 202c extend between and fluidly connect holes 270a and 270b. This connection allows for fluid to pass through the ring 202c in direction X as the ring 200c rotates counter-clockwise as viewed form the front 260. That is, while the example features 202 in FIG. 4 extend between the outer diameter 220 and the front face 260, the holes can be separated from either one or can extend from a location between one of the outer diameter 220 and the front face 260 towards the other the outer diameter 220 and the outer front face 260.

In more detail, according to one embodiment, when the ring rotates clock-wise as viewed from the front surface (260), the fluid flows through the cavity (270c) by entering via 270b and exiting the cavity via 270a.

Of course, if the ring rotates in the clockwise direction, the flow would be in opposite direction. In another embodiment adjustments to the orientations of cavity 270c can be made such that anti-clockwise rotation would yield the same flow path is the clock-wise direction (i.e., enter through 270b and exit through 270a).

While the example features 202 in FIG. 4 extend between the outer diameter 220 and the front face 260, the holes can be separated from either one or can extend from a location between one of the outer diameter 220 and the front face 260 towards the other the outer diameter 220 and the outer front face 260.

By providing the core flow features 202c, simulations have shown better cooling capabilities of the ring 200c than using previous paddle type pumping rings. Similar to the above, will lead to better cooling of at least the rotating ring and possibly the entire seal. As with all embodiments herein, the features 202c can be formed in many manners but one example is to form them via additively manufacturing.

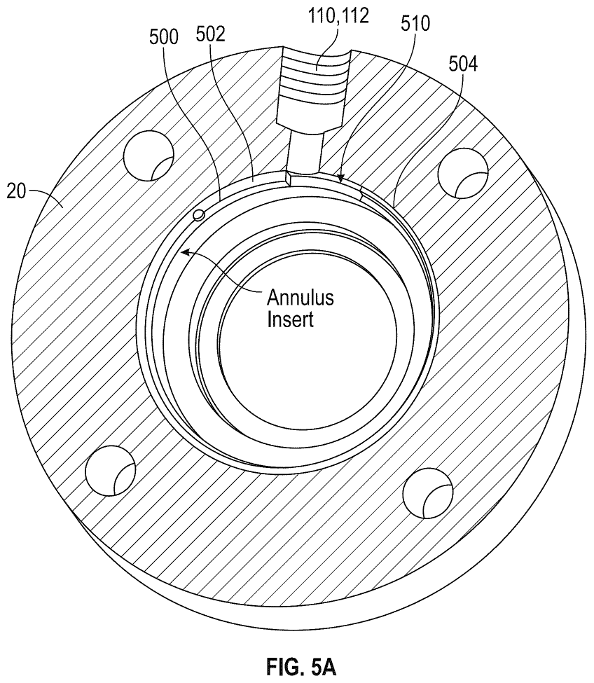

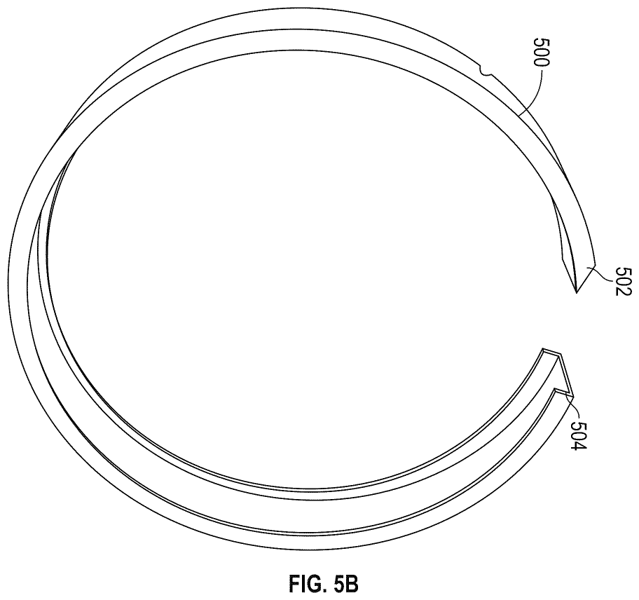

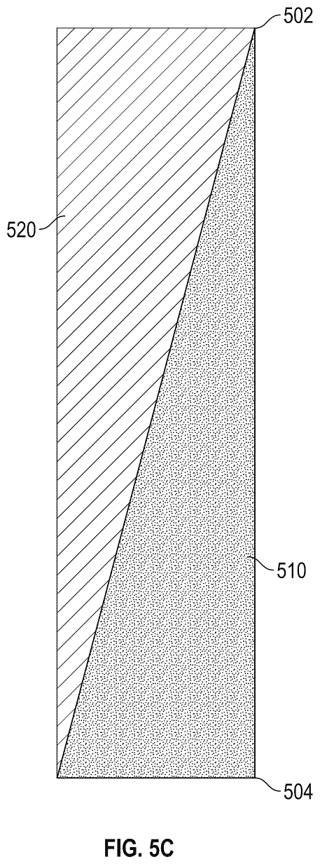

In one embodiment, a volute can be provided within the gland plate 20 as shown in FIG. 5A. This volute 500 can be arranged in the cooling fluid chamber 7 (FIG. 1) such that it surrounds any of the rings 200 disclosed herein in one embodiment. The volute serves to change the shape in the cooling fluid chamber 7 from circular to a non-circular shape such that there is increased circulation of the fluids in the cooling chamber.

In more detail, the volute 500 can include a dam end 502 and flow end 504 as also shown in FIG. 5B. The dam end 502 is thicker than the flow end 504 and, therefore, disrupts smooth circular flow, the dam end 502 can be the flush outlet 112 in embodiment. The volute can be displaced into a groove 510 formed in the gland plate 20.

FIG. 5C shows a flattened plan view of the volute 500. The view shown shows the ID of the volute 500. At the flow end 504 the volute has a first thickness as indicated by first portion 510. As one moves from the flow end 504 to the dam end 502, the volute gets thicker as indicated by second portion 520. Second portion 520 is thicker than the first portion 510. With reference again to FIG. 5A, the volute will therefore provide a larger clearance between the seal/rings at the flow end 504 than at the dam end 502. This, similar to a pump volute and its cutwater, will cause higher pressure to be developed at the flush outlet. A higher outlet pressure induces higher flow.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A pump system comprising:
a pump having a housing and a pump outlet and that is driven by a rotating shaft; and
a mechanical seal assembly coupled to and surrounding the rotating shaft that seals a fluid in a chamber of the pump so that liquid in the chamber exits the pump via the pump outlet, the mechanical seal assembly being disposed in the housing and including:
rotating and stationary rings configured so that rotating ring rotates with the shaft and relative to the stationary ring; and
a rotating ring drive ring that includes features formed at least on an outer surface thereof, the rotating drive ring configured to hold the rotating ring in a fixed relationship relative to the rotating shaft.

2. The pump system of claim 1, wherein the features are wave-like regions.

3. The pump system of claim 2, wherein adjacent features are separated by a trough.

4. The pump system of claim 3, wherein the wave-like regions extend from an outer diameter of the rotating ring drive ring to the trough.

5. The pump system of claim 3, wherein the wave-like regions extend from an outer diameter of the rotating ring drive ring to a location near the trough.

6. The pump system of claim 5, wherein the wave-like regions define a sinusoidal or oscillating pattern.

7. The pump system of claim 1, wherein the features are impeller features or blade like features.

8. The pump system of claim 7, wherein the features are at a front of the rotating ring drive ring.

9. The pump system of claim 8, wherein features extend radially inward from an outer diameter of the rotating ring drive ring.

10. The pump system of claim 9, wherein the features extend to a radial inner wall formed in the front of the rotating ring drive.

11. The pump system of claim 1, wherein the features are channel features.

12. The pump system of claim 11, wherein the features formed such they fluidly connect an outer diameter of the rotating ring drive ring to a front of the rotating ring drive ring.

13. The pump system of claim 12, wherein the features include a hole in the outer diameter and a hole in the front of the rotating ring drive ring and fluidly connect hole in the outer diameter and the hole in the front of the rotating ring drive ring.

14. The pump system of claim 1, further comprising:
a gland plate coupled to the housing such that it defines a cooling chamber between the housing and the rotating and stationary rings, the gland plate including a flush inlet that is in fluid communication with the chamber.

15. The pump system of claim 12, further including a volute disposed or formed in the gland plate and surround the rotating ring drive ring.

16. A mechanical seal assembly configured to be coupled to a rotating shaft of a machine, the seal assembly comprising:
rotating and stationary rings configured so that rotating ring rotates with the shaft and relative to the stationary ring; and
a rotating ring drive ring that includes features formed at least on an outer surface thereof, the rotating drive ring configured to hold the rotating ring in a fixed relationship relative to the rotating shaft.
